(19) United States
(12) Patent Application Publication
(10) Pub. No.: US 2021/0164139 A1
(43) Pub. Date: Jun. 3, 2021

(54) WATER ABSORBING WIPE AND MANUFACTURING METHOD THEREFOR

(71) Applicant: XIAMEN YANJAN NEW MATERIAL CO., LTD., Xiamen, Fujian (CN)

(72) Inventors: Qingzhong Zheng, Xiamen (CN); Shunxin He, Xiamen (CN); Danpin Wu, Xiamen (CN); Jihua Xie, Xiamen (CN)

(21) Appl. No.: 17/263,156

(22) PCT Filed: May 17, 2019
(86) PCT No.: PCT/CN2019/087405

§ 371 Date: Jan. 26, 2021

(30) Foreign Application Priority Data
Jan. 15, 2019 (CN) 201910036695.1

(51) Int. Cl. D04H 1/4382; D04H 1/4374; D04H 1/56; D04H 1/26; B01J 20/28

(52) U.S. Cl. CPC D04H 1/4382; D04H 1/4374; B01J 20/28052; D04H 1/26; B01J 20/28023; D04H 1/56

(57) ABSTRACT

Provided are a water-absorbing wipe and a manufacturing method therefor. The water-absorbing wipe has upper and lower layers of melt-blown fiber webs, and an intermediate layer of a wood pulp fiber web containing a super absorbent resin, wherein melt-blown fibers of the melt-blown fiber webs are woven into the wood pulp fiber web. The super absorbent resin in the water-absorbing wipe can rapidly absorb water or detergent. During wiping, by virtue of the liquid retention ability of the super absorbent resin, the water or the detergent is slowly released to the surface of an object to be cleaned, such that stains can be rapidly removed due to the wetness of the wipe. Moreover, after absorbing a large amount of water or detergent, the wipe can keep the surface dry without leaving behind drops of liquid, and is more suitable for use when the wipe is wet.

### BACKGROUND OF THE INVENTION

### 1. Technical Field

The present invention relates to wipes, and more particularly to a water-absorbing wipe for personal hygiene and baby care. A manufacturing method for the water-absorbing wipe is also disclosed.

### 2. Description of Related Art

Wipes are often used in our daily life when, for example, parents change babies' diapers, people have meals in restaurants, or people do skincare. Since wipes are convenient to carry, store and use, they are popular among consumers and having increasingly extensive use in particularly personal hygiene and baby care.

Wipes can be used dry or wet to wipe off dust and stains, and can work with water or detergent to remove stubborn stains. For improving wipes in terms of moisture absorption and water absorption, a common solution is to add wood pulp during production of wipe products in order to make wipes more effective in moisture absorption and cleaning. However, wood pulp fibers are natural short fibers, and while they absorb moisture well, their liquid retention ability is relatively inferior. This means wood pulp fibers absorbing water tend to inadvertently release the water when receiving a certain external force. Thus, when using a wood-pulp-containing wipe, a user has to frequently pick up water and detergent with the wipe. This not only causes inconvenient use but also tends to leave behind water drops at the surface of an object to be cleaned, being unfavorable to cleaning.

### SUMMARY OF THE INVENTION

The objective of the present invention is to address shortcomings of the existing products and manufacturing methods by providing a water-absorbing wipe having good water absorption ability and liquid retention ability, and providing a manufacturing method therefor.

For achieving the foregoing objective, the present invention implements the following technical schemes.

A water-absorbing wipe has upper and lower layers of melt-blown fiber webs, and an intermediate layer of a wood pulp fiber web containing a super absorbent resin, wherein the melt-blown fibers of the melt-blown fiber webs are woven into the wood pulp fiber web.

The melt-blown fibers are polyolefin fibers, polyester fibers, polyamide fibers, polyurethane fibers, polylactic acid fibers, or a blend thereof.

The melt-blown fiber webs contain one-component melt-blown fibers each having a high-melting-point resin at its surface, melt-blown fibers each having a low-melting-point resin at its surface, or blend fibers of the two.

The high-melting-point resin and the low-melting-point resin have a melting-point difference therebetween of ≥20° C.

The melt-blown fibers each having the low-melting-point resin at its surface are one-component melt-blown fibers, two-component melt-blown fibers, or a blend of the two.

The two-component melt-blown fibers are two-component skin-core melt-blown fibers, two-component segmented-pie melt-blown fibers, or two-component side-by-side melt-blown fibers.

The melt-blown fiber webs each form a water-repellent fiber layer.

The melt-blown fiber webs each comprise hydrophilic melt-blown fibers.

The super absorbent resin is present in the wood pulp fiber web in an amount of 1˜15 g/m².

A weight percentage of the wood pulp fiber web in the water-absorbing wipe is greater than 50 wt %.

A weight percentage of the wood pulp fiber web in the water-absorbing wipe is 65 wt %-80 wt %.

A manufacturing method for a water-absorbing wipe comprises the following steps:

(1) mixing wood pulp that has been opened and scattered by an opening roller with the super absorbent resin into a mixture, and blowing the mixture using a blowing nozzle in the presence of an auxiliary air stream to form the wood pulp fiber web containing the super absorbent resin;

(2) performing a melt blowing process involving heating and melting a thermoplastic resin; dispersing melt streams of the thermoplastic resin that have been extruded from spinneret plates into fiber bundles having a diameter of ≤10 μm using a high-temperature, high-speed hot air stream, thereby forming the melt-blown fiber webs in the presence of the hot air stream; and joining the melt-blown fiber webs with two side surfaces of the wood pulp fiber web containing the super absorbent resin, so as to form a multi-layer fiber web having the melt-blown fiber webs at its two sides and having the wood pulp fiber web containing the super absorbent resin in its middle; and

(3) binding the fiber webs in the multi-layer fiber web together using a heating device, so as to form the water-absorbing wipe having the upper and lower layers of the melt-blown fiber webs and having the intermediate layer of the wood pulp fiber web containing the super absorbent resin.

In the step (2), the thermoplastic resin includes two thermoplastic resins having a melting-point therebetween of ≥20° C., in which the melt-blown fiber webs contain one-component melt-blown fibers each having a high-melting-point resin at its surface, melt-blown fibers each having a low-melting-point resin at its surface, or blend fibers of the two.

The melt-blown fibers each having the low-melting-point resin at its surface are one-component melt-blown fibers, two-component melt-blown fibers, or a blend of the two, and the spinneret plates have two-component spinneret orifices.

The heating device is a hot air oven, a hot rolling roller or a combination thereof.

The thermoplastic resin of the step (2) is heated and melted together with a hydrophilic masterbatch.

The manufacturing method for the water-absorbing wipe further comprises a step (4), after the water-absorbing wipe is formed in the step (3), coating upper and lower surfaces of the water-absorbing wipe with a hydrophilic coating.

By adopting the aforementioned technical schemes, the present invention provides a water-absorbing wipe made using the manufacturing method. With the super absorbent resin in the wood pulp fiber web of the intermediate layer of the disclosed water-absorbing wipe, the water-absorbing wipe when being wetted with water or detergent can have the super absorbent resin rapidly absorb water or the detergent. During wiping, the water-absorbing wipe can prevent water or the detergent from being excessively transferred to the object to be wiped, which could otherwise cause difficulty in cleaning the excessive water or detergent. Instead, it uses the liquid retention ability of the super absorbent resin to slowly release the water or the detergent to the surface of the object to be cleaned, such that stains can be rapidly removed due to the wetness of the wipe. After absorbing a large amount of water or detergent, the wipe can keep the surface dry without leaving behind drops of liquid, and is more suitable for use when the wipe is wet. Moreover, the water-absorbing wipe is effective in removing stains caused by liquids, such as water and urine from the surface of the object to be wiped.

### BRIEF DESCRIPTION OF THE DRAWINGS

FIG. 1 is a schematic drawing illustrating manufacturing of a water-absorbing wipe according to Embodiment 1 of the present invention;

FIG. 2 is a cross-sectional view of the water-absorbing wipe according to Embodiment 1 of the present invention;

FIG. 3 is a cross-sectional view of a water-absorbing wipe according to Embodiment 2 of the present invention;

FIG. 4A is a cut-away view of a skin-core melt-blown fiber according to the present invention;

FIG. 4B is a cut-away view of a two-component side-by-side melt-blown fiber according to the present invention;

FIG. 4C is a cut-away view of a two-component segmented-pie melt-blown fiber according to the present invention;

FIG. 5 is a schematic drawing illustrating manufacturing of a water-absorbing wipe according to Embodiment 3 of the present invention; and

FIG. 6 is a schematic drawing illustrating manufacturing of a water-absorbing wipe according to Embodiment 4 of the present invention

### DETAILED DESCRIPTION OF THE INVENTION

For further illustrating the technical schemes of the present invention, the following detailed description of the present invention will be made with reference to particular embodiments.

### Embodiment 1

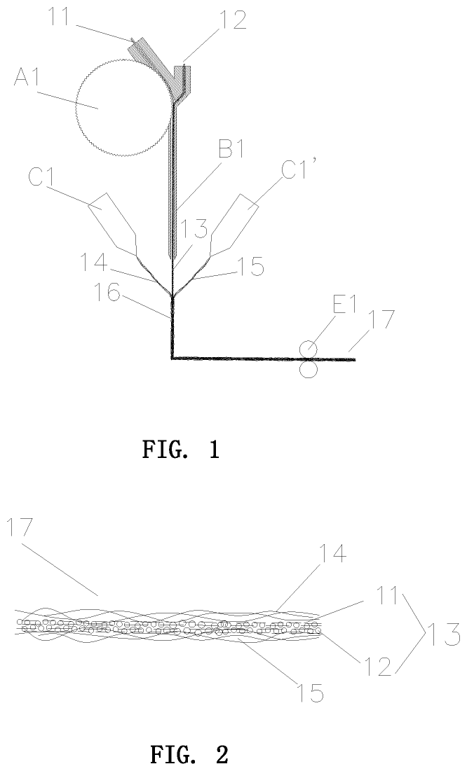

As shown in FIG. 1, the present invention discloses a manufacturing method for a water-absorbing wipe. The method comprises the following steps:

(1) mixing wood pulp 11 that has been opened and scattered by an opening roller A1 with a super absorbent resin 12 into a mixture, and blowing the mixture using a blowing nozzle B1 in the presence of an auxiliary air stream to form a wood pulp fiber web 13 containing the super absorbent resin 112;

(2) performing a melt blowing process involving heating and melting a thermoplastic resin; dispersing melt streams of the thermoplastic resin that have been extruded from spinneret plates C1, C1′ into fiber bundles having a diameter of ≤10 μm using a high-temperature, high-speed hot air stream, thereby forming melt-blown fiber webs 14, 15 in the presence of the hot air stream; and joining the melt-blown fiber webs 14, 15 with two side surfaces of the wood pulp fiber web 13, so as to form a multi-layer fiber web 16 having the melt-blown fiber webs 14, 15 at its two sides and having the wood pulp fiber web 13 containing the super absorbent resin 12 in its middle, wherein a weight percentage of the wood pulp fiber web 13 in the multi-layer fiber web 16 is 70 wt %, and the super absorbent resin 12 is present in the wood pulp fiber web in an amount of 4 g/m², while the melt-blown fiber webs 14, 15 form water-repellent fiber layers; and

(3) binding the fiber webs in the multi-layer fiber web 16 together using a pair of hot rolling rollers E1 that engage with each other, so as to form the water-absorbing wipe 17 having the upper and lower layers of melt-blown fiber webs 14, 15 and having the intermediate layer of the wood pulp fiber web 13 containing the super absorbent resin 12.

As shown in FIG. 2, the present invention further discloses a water-absorbing wipe made using the foregoing manufacturing method. The water-absorbing wipe has a laminated structure. The water-absorbing wipe 17 has the upper and lower layers of the melt-blown fiber webs 14, 15, and has the intermediate layer of the wood pulp fiber web 13 containing the super absorbent resin 12. The melt-blown fibers of the melt-blown fiber webs 14, 15 are woven into the wood pulp fiber web 13. The melt-blown fibers are polyolefin fibers, polyester fibers, polyamide fibers, polyurethane fibers, polylactic acid fibers, or a blend thereof. The blend refers to a blend of two, three, four or all five of polyolefin fibers, polyester fibers, polyamide fibers, polyurethane fibers, and polylactic acid fibers.

With the super absorbent resin 12 in the wood pulp fiber web 13 of the intermediate layer of the water-absorbing wipe 17, the water-absorbing wipe 17 when being wetted with water or detergent can have the super absorbent resin 12 rapidly absorb the water or the detergent. During wiping, by virtue of the liquid retention ability of the super absorbent resin 12, the water or the detergent is slowly released to the surface of an object to be cleaned, such that stains can be rapidly removed due to the wetness of the wipe. Moreover, after absorbing a large amount of water or detergent, the water-absorbing wipe 17 can keep the surface dry without leaving behind drops of liquid, and is more suitable for use when the wipe is wet.

### Embodiment 2

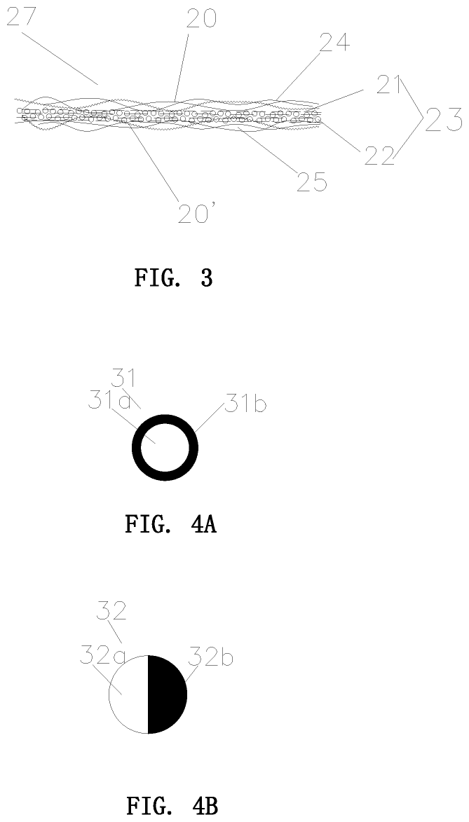

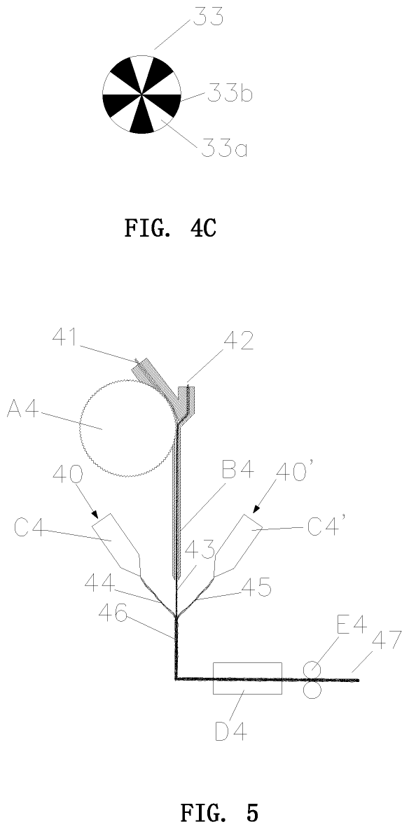

As shown in FIG. 3, the present invention discloses a water-absorbing wipe, which has a laminated structure. The water-absorbing wipe 27 has upper and lower layers of melt-blown fiber webs 24, 25, and has an intermediate layer of a wood pulp fiber web 23 containing a super absorbent resin 22 in addition to wood pulp 21. Therein, melt-blown fibers of the melt-blown fiber webs 24, 25 are woven into the wood pulp fiber web 13. The melt-blown fiber webs 24, 25 may contain one-component melt-blown fibers 20 each having a high-melting-point resin at its surface, melt-blown fibers 20′ each having a low-melting-point resin at its surface, or blend fibers of the two. The high-melting-point resin and the low-melting-point resin have a melting-point difference therebetween of ≥20° C. The melt-blown fibers 20′ each having a low-melting-point resin at its surface may be one-component melt-blown fibers, two-component melt-blown fibers, or a blend of the two. As shown in FIG. 4A through FIG. 4C, the two-component melt-blown fibers may be skin-core melt-blown fibers 31, two-component segmented-pie melt-blown fibers 33, or two-component side-by-side melt-blown fibers 32. Besides, for the skin-core melt-blown fiber 31, its skin layer resin 31b has a melting point lower than a melting point of its core layer resin 31a. For the two-component segmented-pie melt-blown fiber 33 and two-component side-by-side melt-blown fiber 32, one of their constituent resin 32b, 33b has a melting point lower than a melting point of the other constituent resin 32a, 33a. The two-component melt-blown fibers are made by heating and melting two thermoplastic resins having a melting-point difference therebetween of ≥20° C., and blowing into fibers through two-component spinneret orifices provided on spinneret plates.

Since the melt-blown fiber webs 24, 25 contains the melt-blown fibers 20′ each having a low-melting-point resin at its surface, when the low-melting-point resin in the melt-blown fibers is melted in a hot air oven, the fibers are bound together. This not only enhances the overall strength of the resulting wipe, but also leads to a dense arrangement of the melt-blown fibers, while endowing an adhesive attached to the surfaces of the melt-blown fiber webs 24, 25 with improved adhesion. Consequently, the resulting wipe is more wear resistant, and unlikely to pill and fuzz. In addition, the super absorbent resin contained in the wood pulp fiber web 23 of the intermediate layer makes the wipe suitable for use when being wetted with water or detergent, as it prevents the water or the detergent from being excessively transferred to the object to be wiped, which could otherwise degrade the wiping effect.

### Embodiment 3

As shown in FIG. 5, the present invention discloses a manufacturing method for a water-absorbing wipe. The manufacturing method comprises the following steps:

(1) mixing wood pulp 41 that has been opened and scattered by an opening roller A4 with a super absorbent resin 42 into a mixture, and blowing the mixture using a blowing nozzle B4 in the presence of an auxiliary air stream to form a wood pulp fiber web 43 containing the super absorbent resin 42;

(2) performing a melt blowing process involving heating and melting a thermoplastic resin and a hydrophilic masterbatch 40, 40′; dispersing melt streams of the thermoplastic resin and the hydrophilic masterbatch 40, 40′ that have been extruded from spinneret plates C4, C4′ into fiber bundles having a diameter of ≤10 μm using a high-temperature, high-speed hot air stream, thereby forming the melt-blown fiber webs 44, 45 in the presence of the hot air stream; and joining the melt-blown fiber webs with two side surfaces of the wood pulp fiber web 43 containing the super absorbent resin 42, so as to form a multi-layer fiber web 46 having the hydrophilic melt-blown fiber webs 44, 45 at its two sides and having the wood pulp fiber web 43 containing the super absorbent resin 42 in its middle, wherein a weight percentage of the wood pulp fiber web 43 in the multi-layer fiber web 46 is 78 wt %, and the super absorbent resin 42 is present in the wood pulp fiber web in an amount of 5 g/m², while the melt-blown fiber webs 44, 45 comprise hydrophilic melt-blown fibers; and

(3) binding the fiber webs in the multi-layer fiber web 46 together using a hot air oven D4 and a pair of hot rolling rollers E4 that engage with each other, so as to form the water-absorbing wipe 47 having the upper and lower layers of hydrophilic melt-blown fiber webs 44, 45 and having the intermediate layer of the wood pulp fiber web 43 containing the super absorbent resin 42.

Since the melt-blown fiber webs 44, 45 comprise hydrophilic melt-blown fibers, the water-absorbing wipe 47 has improved surface wettability, which allows water or detergent to rapidly wet the water-absorbing wipe 47 and be absorbed by the super absorbent resin 42 contained in the water-absorbing wipe 47, thus being suitable for use when the wipe is wet. Meanwhile, the hydrophilic fibers at the surfaces of the water-absorbing wipe 47 can readily absorb water stains and urine stains on an object to be wiped, thereby removing liquids, such as water stains or urine stains, from the surface of the object to be wiped rapidly. Additionally, the melt-blown fiber webs 44, 45 of the water-absorbing wipe 47 are hydrophilic melt-blown fiber webs 44, 45 made with the hydrophilic masterbatch added, and this provides the advantages of easy processing and long-lasting hydrophilicity.

### Embodiment 4

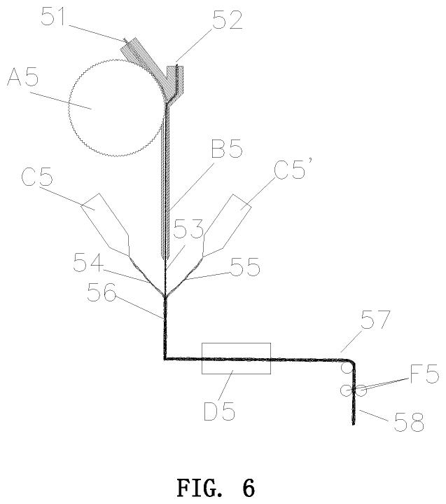

As shown in FIG. 6, the present invention discloses a manufacturing method for a water-absorbing wipe. The manufacturing method comprises the following steps:

(1) mixing wood pulp 51 that has been opened and scattered by an opening roller A5 with a super absorbent resin 52 into a mixture, and blowing the mixture using a blowing nozzle B5 in the presence of an auxiliary air stream to form a wood pulp fiber web 53 containing the super absorbent resin 52;

(2) performing a melt blowing process involving heating and melting two thermoplastic resins having a melting-point difference therebetween of ≥20° C.; dispersing melt streams of the thermoplastic resins that have been extruded from spinneret plates C5, C5′ into fiber bundles having a diameter of ≤10 μm using a high-temperature, high-speed hot air stream, thereby forming the melt-blown fiber webs 54, 55 in the presence of the hot air stream, wherein the melt-blown fiber webs 54, 55 containing melt-blown fibers each having a high-melting-point resin at its surface, melt-blown fibers each having a low-melting-point resin at its surface, or blend fibers of the two; and joining the melt-blown fiber webs 54, 55 with two side surfaces of the wood pulp fiber web 53 containing the super absorbent resin 52, so as to form a multi-layer fiber web 56 having the hydrophilic melt-blown fiber webs 54, 55 at its two sides and having the wood pulp fiber web 53 containing the super absorbent resin 52 in its middle, wherein a weight percentage of the wood pulp fiber web 53 in the multi-layer fiber web 56 is 75 wt %, and the super absorbent resin 52 is present in the wood pulp fiber web in an amount of 3 g/m²;

(3) binding the fiber webs in the multi-layer fiber web 56 together using a hot air oven D5, so as to form the water-absorbing wipe 57 having the upper and lower layers of hydrophilic melt-blown fiber webs 54, 55 and having the intermediate layer of the wood pulp fiber web 53 containing the super absorbent resin 52; and

(4) after the water-absorbing wipe is formed in the step (3), coating upper and lower surfaces of the water-absorbing wipe with a hydrophilic coating by performing a roll coating process using a pair of coating rollers F5, where a hydrophilic coating is applied to two sides of the water-absorbing wipe 57 to have the hydrophilic coating cover the surfaces of the melt-blown fibers, thereby forming hydrophilic melt-blown fibers, and in turn forming the water-absorbing wipe 58 having upper and lower layers of the hydrophilic melt-blown fiber webs 54, 55 and having an intermediate layer of the wood pulp fiber web 53 containing the super absorbent resin 52.

The melt-blown fibers of the water-absorbing wipe 58 are hydrophilic melt-blown fibers formed by means of roll coating, which have high hydrophilicity and are highly absorbent for both liquid stains on surfaces objects being wiped such as water stains or urine stains and water or detergent, making the water-absorbing wipe 58 more useful in wet environments.

What is claimed is:

1. A water-absorbing wipe, comprising upper and lower layers of melt-blown fiber webs and an intermediate layer of a wood pulp fiber web that contains a super absorbent resin, wherein melt-blown fibers of the melt-blown fiber webs are woven into the wood pulp fiber web.

2. The water-absorbing wipe of claim 1, wherein the melt-blown fibers are polyolefin fibers, polyester fibers, polyamide fibers, polyurethane fibers, polylactic acid fibers, or a blend thereof.

3. The water-absorbing wipe of claim 1, wherein the melt-blown fiber webs contain one-component melt-blown fibers each having a high-melting-point resin at its surface, melt-blown fibers each having a low-melting-point resin at its surface, or blend fibers of the two.

4. The water-absorbing wipe of claim 3, wherein the high-melting-point resin and the low-melting-point resin have a melting-point difference therebetween of ≥20° C.

5. The water-absorbing wipe of claim 3, wherein the melt-blown fibers each having the low-melting-point resin at its surface are one-component melt-blown fibers, two-component melt-blown fibers, or a blend of the two.

6. The water-absorbing wipe of claim 5, wherein the two-component melt-blown fibers are two-component skin-core melt-blown fibers, two-component segmented-pie melt-blown fibers, or two-component side-by-side melt-blown fibers.

7. The water-absorbing wipe of claim 1, wherein the melt-blown fiber webs each form a water-repellent fiber layer.

8. The water-absorbing wipe of claim 1, wherein the melt-blown fiber webs each comprise hydrophilic melt-blown fibers.

9. The water-absorbing wipe of claim 1, wherein the super absorbent resin is present in the wood pulp fiber web in an amount of 1-15 g/m².

10. The water-absorbing wipe of claim 1, wherein a weight percentage of the wood pulp fiber web in the water-absorbing wipe is greater than 50 wt %.

11. The water-absorbing wipe of claim 1, wherein a weight percentage of the wood pulp fiber web in the water-absorbing wipe is 65 wt %-80 wt %.

12. A manufacturing method for the water-absorbing wipe of claim 1, comprising steps of:
(1) mixing wood pulp that has been opened and scattered by an opening roller with the super absorbent resin into a mixture, and blowing the mixture using a blowing nozzle in the presence of an auxiliary air stream to form the wood pulp fiber web containing the super absorbent resin;
(2) performing a melt blowing process involving heating and melting a thermoplastic resin; dispersing melt streams of the thermoplastic resin that have been extruded from spinneret plates into fiber bundles having a diameter of ≤10 μm using a high-temperature, high-speed hot air stream, thereby forming the melt-blown fiber webs in the presence of the hot air stream; and joining the melt-blown fiber webs with two side surfaces of the wood pulp fiber web containing the super absorbent resin, so as to form a multi-layer fiber web having the melt-blown fiber webs at its two sides and having the wood pulp fiber web containing the super absorbent resin in its middle; and
(3) binding the fiber webs in the multi-layer fiber web together using a heating device, so as to form the water-absorbing wipe having the upper and lower layers of the melt-blown fiber webs and having the intermediate layer of the wood pulp fiber web containing the super absorbent resin.

13. The manufacturing method of claim 12, wherein in the step (2), the thermoplastic resin includes two thermoplastic resins having a melting-point therebetween of ≥20° C., in which the melt-blown fiber webs contain one-component melt-blown fibers each having a high-melting-point resin at its surface, melt-blown fibers each having a low-melting-point resin at its surface, or blend fibers of the two.

14. The manufacturing method of claim 13, wherein the melt-blown fibers each having the low-melting-point resin at its surface are one-component melt-blown fibers, two-component melt-blown fibers, or a blend of the two, and the spinneret plates have two-component spinneret orifices.

15. The manufacturing method of claim 12, wherein the heating device is a hot air oven, a hot rolling roller or a combination thereof.

16. The manufacturing method of claim 12, wherein the thermoplastic resin of the step (2) is heated and melted together with a hydrophilic masterbatch.

17. The manufacturing method of claim 12, further comprising a step (4), which comprises after the water-absorbing wipe is formed in the step (3), coating upper and lower surfaces of the water-absorbing wipe with a hydrophilic coating.
